(19) United States
(12) Patent Application Publication
(10) Pub. No.: US 2010/0275576 A1
(43) Pub. Date: Nov. 4, 2010

(54) SYSTEM AND METHOD FOR MANEUVERING ROCKETS

(75) Inventors: Shaul Gutman, Yavne-el (IL); Benveniste Natan, Haifa (IL)

Correspondence Address: BROWDY AND NEIMARK, P.L.L.C.;624 NINTH STREET, NW, SUITE 300, WASHINGTON, DC, 20001-5303, US

(73) Assignee: TECHNION - RESEARCH & DEVELOPMENT FOUNDATION LTD., Haifa (IL)

(21) Appl. No.: 12/772,487

(22) Filed: May 3, 2010

(30) Foreign Application Priority Data
May 4, 2009 (IL) 198538

(51) Int. Cl. F02K 9/08

(52) U.S. Cl. 60/204; 60/253

(57) ABSTRACT

A dual control system for a solid propellant propelled exoatmospheric kill-vehicle is disclosed. The system includes a primary solid propellant propulsion mechanism for controlling the propulsion of the kill-vehicle during a first phase of rocket flight, and a secondary solid propellant propulsion mechanism for maneuvering the kill-vehicle during a second phase of rocket flight. The primary propulsion mechanism controls the propulsion and direction of the kill-vehicle towards its target while the secondary propulsion mechanism may be used to provide lateral acceleration with a lower time-constant.

### FIELD OF THE INVENTION

The present invention relates to systems and methods for directing anti-ballistic missiles towards a moving target. More specifically, the system refers to propulsion systems for maneuvering exoatmospheric kill-vehicles.

### BACKGROUND

Kill-vehicles are anti-ballistic missiles which may be deployed for the purpose of destroying fast moving ballistic missiles. Some kill-vehicles carry their own warheads which may be detonated within range of the target missile. Other kill-vehicles, known as kinetic kill-vehicles rely upon the kinetic energy released upon collision with their target. In either case, it is necessary for the kill-vehicle to hit, or at least reach the vicinity of, a fast moving distant target with a high degree of accuracy.

Ballistic missiles may attempt to avoid interception by kill-vehicles by deviating from their projected trajectory. U.S. Pat. No. 7,350,744 to Schwartz and Woods titled, “System for changing warhead's trajectory to avoid interception” describes one system in which a warhead has one or more thrusters, which cause it to deviate from its projected trajectory. An on-board computer controls the thrusters' ignition and burning time in a closed loop with an on-board Global Positioning System (GPS) unit. The GPS data is used for predicting the warhead's trajectory and to assure that the thrusters provide motion displacements of the warhead.

Successful kill-vehicles need to counter such deviations. Apart from carrying their own warheads which may be detonated in the vicinity of the target, other counter methods include increasing the effective strike area of the kill-vehicle. For example, one method is described in U.S. Pat. No. 7,412,916 to Lloyd, titled “Fixed deployed net for hit-to-kill vehicle”. In Lloyd's method, the kill-vehicle deploys a net including a plurality of rods held in a spaced relationship by the net for destroying the target. An alternative method for increasing effective strike area is described in U.S. Pat. No. 7,494,090 to Leal et al., titled “Multiple kill vehicle (MKV) interceptor with autonomous kill vehicles”. Leal describes an interceptor which includes multiple kill vehicles each having autonomous management capability. When within range of their target Leal's autonomous kill-vehicles may be deployed to increase the kinematic reach of the interceptor. The abovedescribed methods illustrate the long felt need for effective counter measures to deviating targets.

Another counter measure which may be used by a kill-vehicle to hit a target deviating from its trajectory is to steer the kill-vehicle towards the deviating target. To this end, kill-vehicles may use sensors for identifying and tracking the target, control systems for computing changes to the kill-vehicle's course and steering systems for directing the kill-vehicle towards its deviating target. The development of effective steering systems can be particularly problematic.

Typical atmospheric steering systems include adjustable aerodynamic elements such as wing-flaps, fins, tails and rudders. However aerodynamic solutions are only suitable in air rich environments. Exoatmospheric kill-vehicles need to maneuver in airless environments in which aerodynamic elements are ineffective. Therefore rocket engines are required to provide the maneuverability required.

The attitude of an exoatmospheric kill-vehicle may be controlled using an array of jet thrusters or flexible nozzles for controlling yaw, pitch and roll angles. These jets are typically generated using liquid propellants fed to the thrusters through pressurized systems.

Liquid propellants, such as liquid hydrogen, liquid oxygen, nitrogen tetraoxide and the like, are highly reactive and are difficult to store for long periods. Consequently, when liquid bipropellant is used in launchers, the propellant is generally added shortly before the launch. This may not be appropriate for anti-ballistic missiles which, by their nature, typically need to be deployed at short notice. Hydrazine and its derivatives, which are often used as monopropellant in satellites, may also be used for military applications. However, although hydrazine may be stored for longer periods, it is highly toxic, requires a lot of maintenance and can be difficult and dangerous to handle.

Solid propellants may be preferred for military purposes as they are much easier to handle and to store for long periods. However solid propellants cannot be piped, through pressurized systems, to jet thrusters for controlling yaw, pitch and roll angles of kill-vehicle.

It will be appreciated that there is therefore a need for a solid propellant based solution for maneuvering exoatmospheric kill-vehicles and the present invention addresses this need.

### SUMMARY OF THE INVENTION

Embodiments of the current invention are directed towards providing a dual control system for a solid propellant propelled exoatmospheric kill-vehicle. The system typically comprises: a primary solid propellant propulsion mechanism for controlling the propulsion of the kill-vehicle during a first phase of rocket flight, and a secondary solid propellant propulsion mechanism for maneuvering the kill-vehicle during a second phase of rocket flight.

Preferably, the dual control system comprises a tail thruster unit. Optionally, the dual control system further comprises a nose thruster unit. The tail thruster unit is generally situated behind the center of gravity of the kill-vehicle. The nose thruster unit is generally situated ahead of the center of gravity of the kill-vehicle.

Optionally, the tail thruster unit comprises a thrust-vector-control solid rocket. Typically, the tail thruster unit further comprises a plurality of side jets. Variously, the tail thruster unit further comprises two, four or more side jets.

Optionally, the nose thruster unit comprises a rocket cluster. Variously the rocket cluster comprises two, four or more side solid propellant rockets. The rocket-cluster may comprise at least one double-nozzled rocket. In certain embodiments at least one rocket may be mounted upon an extendable arm. Typically, the extendable arm is retractable into a fuselage of the exoatmospheric kill-vehicle.

According to preferred embodiments of the invention, the primary solid propellant propulsion mechanism comprises the thrust-vector-control solid rocket. Typically, the secondary solid propellant propulsion mechanism comprises the plurality of side jets. Optionally, the secondary solid propellant propulsion mechanism comprises a nose thruster unit. Typically, the secondary solid propellant propulsion mechanism comprises the plurality of side jets and further comprises a nose thruster unit.

Typically, the second phase of the rocket flight begins within ten missile time-constants of impact. Optionally, the second phase of the rocket flight begins three seconds before impact.

Optionally, at least one propulsion mechanism is controlled by at least one control element selected from the group consisting of jet shutters, hot gas valves, extendable arms, steerable nozzles and motorized axes. Typically, at least one propulsion mechanism is controlled by an autopilot. The autopilot may receive signals from sensors. Alternatively or additionally, the autopilot receives signals from a remote control unit.

Generally, the primary propulsion mechanism is characterized by a first missile response time-constant and the secondary propulsion mechanism is characterized by a second missile response time-constant. Typically, the second missile response time-constant is shorter than the first missile response time-constant. The second missile response time-constant may be approximately 0.05 seconds.

Other embodiments of the current invention are directed towards teaching a method for maneuvering a solid propellant propelled exoatmospheric kill-vehicle towards a moving target, the method comprising the steps: (a) providing a dual control system comprising a primary solid propellant propulsion mechanism and a secondary solid propellant propulsion mechanism; (b) maneuvering the kill-vehicle using the primary propulsion mechanism during a first phase of rocket flight, and (c) maneuvering the kill vehicle towards the target using the secondary propulsion during a second phase of rocket flight. Optionally, the second phase begins within ten first missile time-constants of impact. Typically, the second phase begins three seconds before impact.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic diagram of an exoatmospheric kill-vehicle according to one embodiment of the current invention;

FIGS. 2a-d are schematic diagrams showing various embodiments of the tail thruster unit for use with the exoatmospheric kill-vehicle;

FIG. 3a is a schematic diagram showing a possible embodiment of the nose thruster unit for use with the exoatmospheric kill-vehicle;

FIGS. 3b-c are schematic representation of a further embodiment of the nose thruster unit in which the small rockets are longer than the diameter of the kill-vehicle;

FIGS. 4a and 4b show two configurations of another embodiment of the exoatmospheric kill vehicles having rockets mounted upon extendable arms according to still another embodiment of the invention, and

FIG. 5 is a flowchart representing a method for maneuvering an exoatmospheric kill-vehicle according to embodiments of the invention.

### DESCRIPTION OF THE PREFERRED EMBODIMENTS

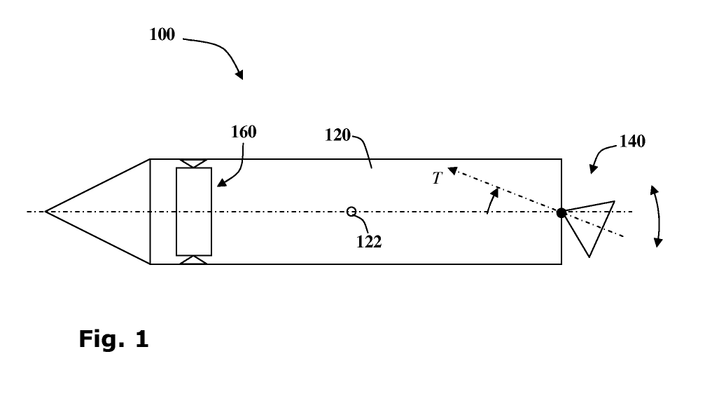

Reference is now made to FIG. 1 which shows a schematic diagram of an exoatmospheric kill-vehicle 100 according to one embodiment of the current invention. The exoatmospheric kill-vehicle includes a missile body 120, a thrust-vector control (TVC) solid propellant rocket 140 and a solid propellant rocket-cluster (RC) 160.

Evasive measures may be taken by ballistic missile targets causing them to deviate from a projected trajectory. When the configuration of the kill-vehicle's rockets are altered in response to such deviations, the kill-vehicle's acceleration does not change instantaneously. The rate of increase of the kill-vehicle's acceleration is characterized by a time-constant, which is typically around 0.3 seconds.

Studies have shown that significant miss distance may be developed by evasive action taken by a ballistic missile target within ten missile's time-constants of predicted impact. Therefore, successful evasive maneuvers typically take place during the last three seconds or so before a kill In order to overcome such evasive actions, embodiments of the current invention aim to reduce the missiles time-constant thereby reducing the time available for the target missile's diversionary maneuvers.

It is a particular feature of embodiments of the current invention that a dual control system is provided for the kill-vehicle. The dual control system includes a primary propulsion mechanism characterized by a first time-constant and a secondary propulsion mechanism characterized by a second time-constant. The primary propulsion mechanism controls the propulsion and direction of the kill-vehicle towards its target during a first phase of the rocket flight. The secondary propulsion mechanism may be used to provide lateral acceleration with a lower time-constant during a second phase of rocket flight.

In contradistinction to the prior art, embodiments of the present invention are based solely on solid rocket technology with both primary and secondary propulsion mechanisms being propelled by solid propellant. Typically, the primary propulsion mechanism involves only the thrust-vector control solid rocket 140 and the secondary propulsion mechanism involves some combination of the thrust-vector control solid rocket 140 and the solid propellant rocket-cluster 160.

Solid rocket motors generally include a casing, a nozzle, igniter and a propellant charge which is typically in grain form. The propellant burns in a predictable manner producing exhaust gases. Exhaust gases are directed through the nozzle to produce thrust.

The dimensions of the nozzle may be calculated to maintain an optimal design chamber pressure. Furthermore, optionally, steerable nozzles may be provided for rocket guidance and attitude control.

It will be appreciated that solid rockets are particularly suited to military purposes due to the increased reliability of solid rocket propellants such as composite propellant, double-base propellants and the like, for example Ammonium Perchlorate Composite Propellant (APCP). Solid propellants are also safer and easier to handle and maintain. Moreover solid propellants may be stored for long periods without significant degradation. It is further noted that, unlike other solid propellant rocket systems, embodiments of the current invention are not based upon expensive ducts technology, which may be excessively complicated and prone to failure.

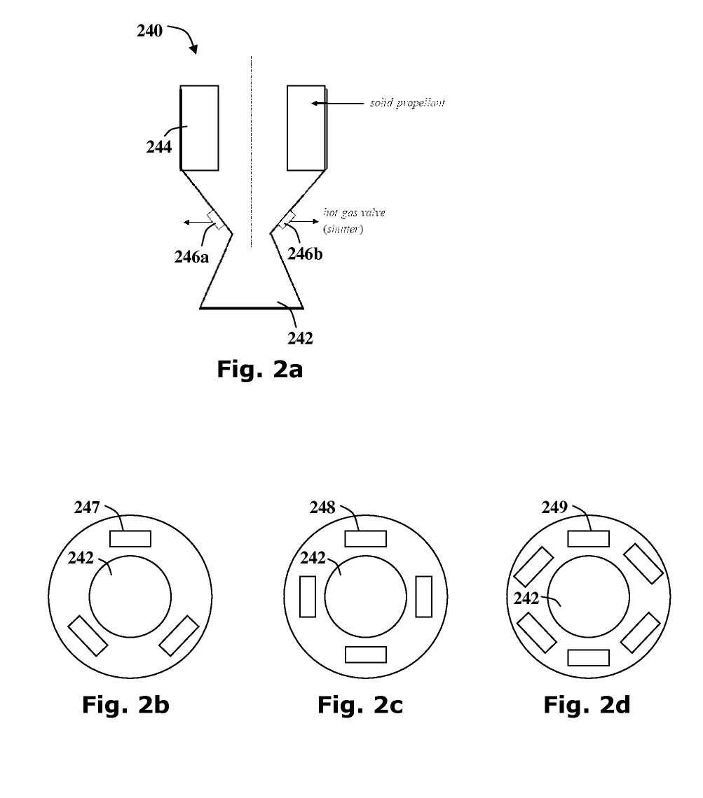

Reference is now made to FIG. 2a which shows a schematic diagram of the tail thruster unit 240 of the exoatmospheric kill-vehicle according to another embodiment of the invention. The tail thruster unit 240 includes a first solid propellant store 244, a thrust-vector control solid rocket, a main engine outlet 242 and two side jets 246a, 246b. The main engine jet 242 and the side jets 246 are controllable by hot gas valve, shutters or the like.

Typically, the main engine jet 242 is open throughout the first phase of the rocket flight. During the second phase of the rocket flight the main engine jet 242 is closed and the side jets 246 are opened. The side jets 246a, 246b may be selectively closed periodically during the second phase to provide lateral acceleration as required.

Although only two side jets 246a, 246b are described in the above embodiment, with reference to FIGS. 2b-d, by way of example only, tail views of alternative embodiments of the tail thruster unit are shown having three side jets 247, four side jets 248 and six side jets 349 respectively.

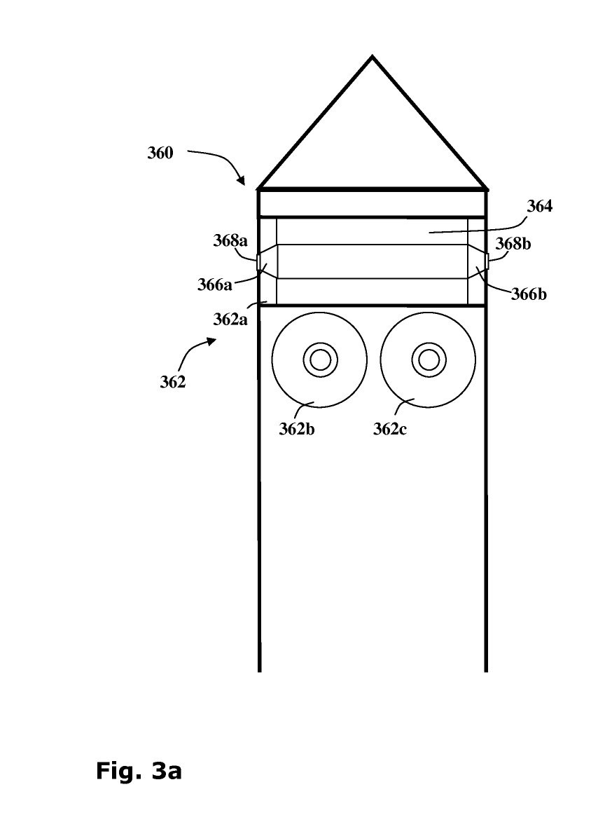

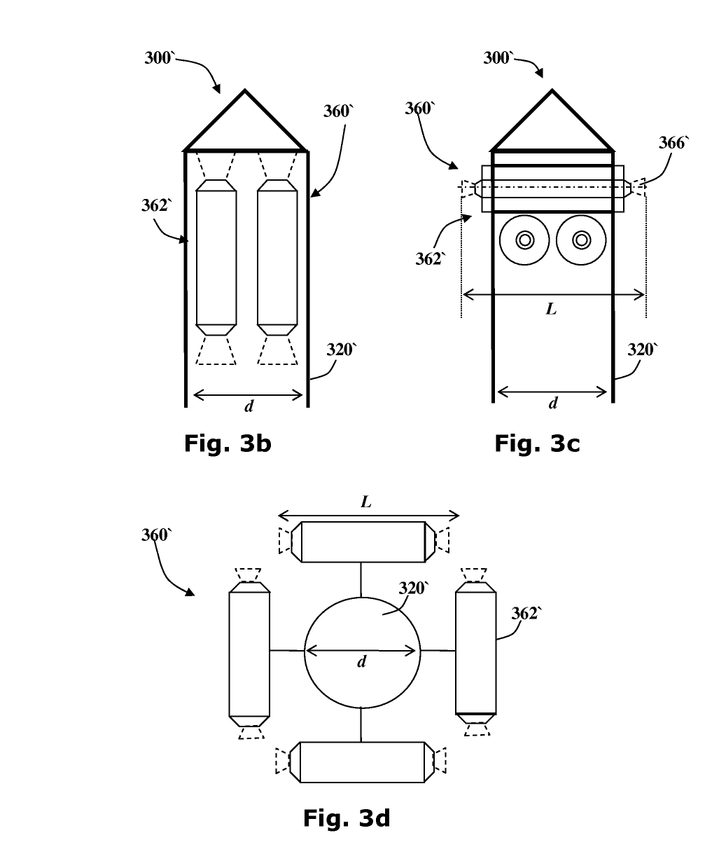

Referring now to FIG. 3a, a schematic diagram is presented showing the nose thruster unit 360 of the exoatmospheric kill-vehicle according to still another embodiment of the invention. The nose thruster unit 360, which is typically operational only during the second phase of the rocket flight, includes a second solid propellant store 364 and a rocket cluster 362. The rocket cluster 362 includes four small solid rockets (three shown) 362a, 362b, 362c.

Although such an additional rocket cluster 362 typically adds additional mass to a kill vehicle. Embodiments of the invention may provide 100 meters per second squared of lateral acceleration for only ten kilograms of mass added to a 100 kilogram kill-vehicle.

Optionally the rocket cluster includes double-nozzled rockets 362a, having two nozzle jets 366a, 366b controlled by individually controlled shutters 368a, 368b. Generally, the time period of activation of the nose thruster unit 362 is short thus the rocket nozzles may be convergent or convergent-divergent. It is a particular feature of embodiments of the invention that the shutters 368a, 368b have a short response time and are normally open throughout the second phase of rocket flight. By selectively closing the shutters 368a, 368b a net lateral force may be exerted upon the nose of the kill-vehicle with a short time-constant.

Preferably, the rocket cluster includes a plurality of rockets orientated in different directions so as to provide forces in a variety of directions. By way of example only, alternative embodiments of the nose thrusters with rocket clusters having two, three and six solid rockets as required to provide the required maneuverability. In still other embodiments, a central rocket burner may provide multiple side jets controllable by shutters, valves or the like. It will be appreciated that other embodiments of the rocket cluster may include different configurations of small rockets.

Reference is now made to FIGS. 3b-d showing a further embodiment of the nose thruster 360′ in which the length L of the small rockets 362′ is longer than the diameter d of the kill-vehicle 300′ of the rocket cluster. With particular reference to FIG. 3b, the nose thruster 360′ is shown in its atmospheric flight configuration. The rockets 362′ are inactive and fully retracted into the fuselage 320′ of the kill-vehicle 300′ such that no protruding elements interfere with the aerodynamics of the kill-vehicle 300′ during atmospheric flight.

FIGS. 3c and 3d shows the nose thruster 360′ in exoatmospheric flight configurations as viewed from the side and nose respectively. Because aerodynamic effects are no longer relevant, the rockets 362′ may be extended from the fuselage 320′ and rotated into orthogonal orientation to the direction of the kill-vehicle 300′. It is noted that such a configuration may be advantageous where longer nose rockets 362′ are required to provide the desired lateral thrust.

Referring back to FIG. 1, it is noted that the nose thruster unit 160 is typically situated ahead of the kill-vehicle's center of gravity 122 whereas the tail thruster unit 140 is typically situated behind the kill-vehicle's center of gravity 122. Thus, by firing specific small rockets selected from the rocket cluster of the nose thruster unit 160 and opening specific side jets of the tail thruster unit 140, the pitch, roll and yaw angles of the kill-vehicle may be controlled. By adjusting the pitch, roll and yaw angles, the kill-vehicle may be maneuvered so as to hit the evading target. Optionally, the secondary propulsion unit may be provided by combing the rocket cluster of the nose thruster unit 160 with the thrust-vector control of the tail thruster unit 140 without opening any side jets of the tail thruster unit 140.

It will be appreciated that embodiments of the invention generally include lateral side jets and rocket clusters which provide lateral thrust. Thus in contradistinction to prior art systems preferred embodiments of the invention may prevent rotation of the missile body 120 causing sensors in the nose of the kill-vehicle to lose sight of a target missile.

In some embodiments of the invention, a first phase autopilot is provided to control the thrust-vector control solid rocket during the first phase of the rocket flight. A second phase autopilot may be additionally provided to control the both the side jets of the tail thruster unit and the rocket cluster of the nose thruster unit during the second phase of the rocket flight.

Typically the second phase autopilot is configured to respond to signals from sensors or from an external remote control providing operational instructions. The autopilot may control guidance mechanisms such as shutters, hot gas valves, extendable arms, steerable nozzles, motorized axes and the like so as maneuver the kill-vehicle as required. Because shutters and gas valves generally have faster response times than motorized axes and steerable nozzles, such control elements may be used to reduce the missile response time-constant during the second phase of the missile flight. In certain embodiments, the missile time-constant during the second phase may be 0.05 seconds or lower, thereby reducing the maximum time available for successful evasive action of a target to around 0.5 seconds or less.

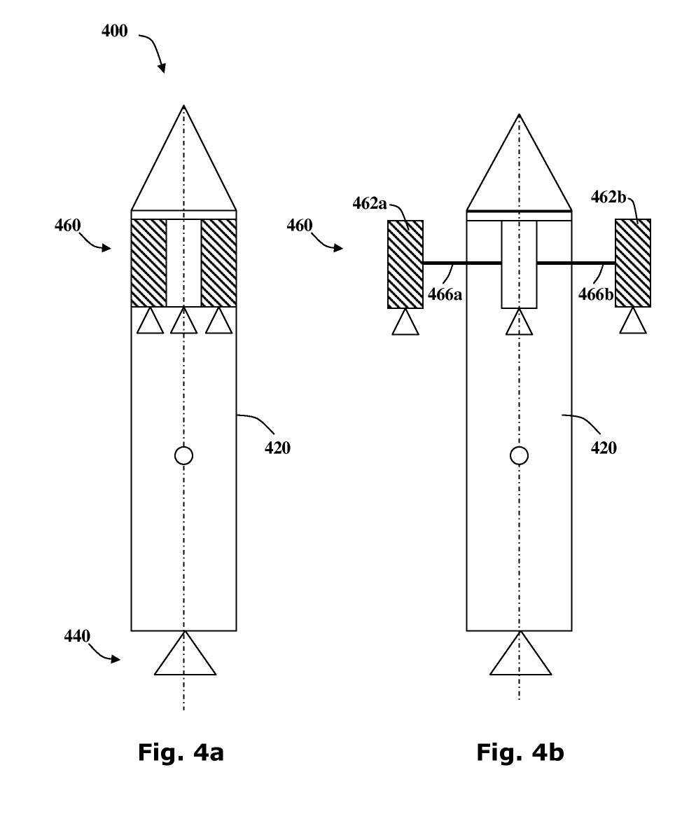

Referring now to FIGS. 4a and 4b, showing an exoatmospheric kill-vehicle 400 according to still another embodiment of the invention. The kill-vehicle 400 includes a nose thruster unit 460 and a tail thruster unit 440. The tail thruster unit 440 again includes a thrust vector solid rocket engine as described in relation to the embodiments above. The nose thruster unit 460 differs from the rocket cluster described hereinabove in that rockets 462a, 462b are mounted upon extendable arms 466a, 466b.

With particular reference to FIG. 4a, the kill vehicle 400 is shown in its atmospheric flight configuration. The rocket cluster is inactive and the extendable arms are fully retracted into the fuselage 420 of the kill-vehicle 400 such that they do not interfere with the aerodynamics of the kill-vehicle 400 during atmospheric flight.

FIG. 4b shows the kill vehicle 400 in its exoatmospheric flight configuration. Because aerodynamic effects are no longer relevant, the extendable arms 466a, 466b are extended from the fuselage 420 of the exoatmospheric kill-vehicle 400. The arms 466 may be used to position nose rockets 462 at specific locations and angles so as to provide the desired changes to the pitch, roll and yaw angles of the kill vehicle in exoatmospheric flight. It is noted that the extended arm configuration may provide greater flexibility and may allow for greater maneuverability of the kill-vehicle.

Typically, the exoatmospheric kill-vehicle is maneuvered towards its target using a method consisting of the following steps: step (a)—providing a dual control system having a primary solid propellant propulsion mechanism and a secondary solid propellant propulsion mechanism; step (b)—maneuvering the kill-vehicle using the primary propulsion mechanism during a first phase of rocket flight, and step (c) maneuvering the kill vehicle towards the target using the secondary propulsion during a second phase of rocket flight.

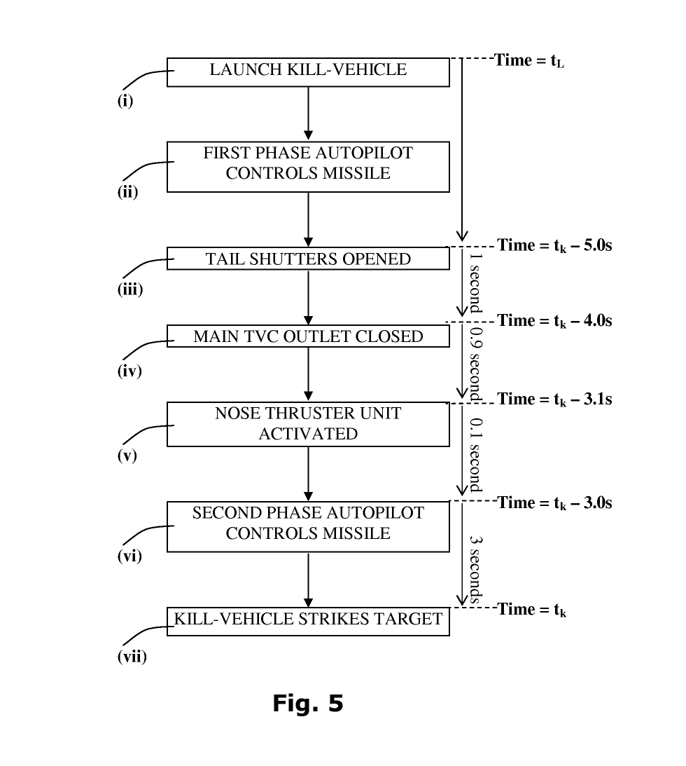

Referring now to FIG. 5, a flowchart is shown representing an exemplary missile flight sequence following the above method. The flight sequence from launch (i) to kill (vii) may be described as follows:
(ii) Up to 5 seconds before impact, the standard TVC controls the missile using a first phase autopilot;
(iii) at, or around, 5 seconds before impact, four TVC tail shutters are opened, the first phase autopilot continues as before;
(iv) at, or around, 4 seconds before impact, the main TVC outlet is shut off, the first phase autopilot continues as before;
(v) at, or around, 3.1 seconds before impact, the rocket cluster is initiated nose shutters remain open, and
(vi) from about 3 second before impact until impact, the first phase autopilot transfers control to the second phase autopilot.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A dual control system for a solid propellant exoatmospheric kill-vehicle, said system comprising:
a primary solid propellant propulsion mechanism for controlling the propulsion of said kill-vehicle during a first phase of rocket flight, and
a secondary solid propellant propulsion mechanism for maneuvering said kill-vehicle during a second phase of rocket flight.

2. The dual control system of claim 1 comprising a tail thruster unit.

3. The dual control system of claim 2 further comprising a nose thruster unit.

4. The dual control system of claim 2 wherein said tail thruster unit is situated behind the center of gravity of said kill-vehicle.

5. The dual control system of claim 3 wherein said nose thruster unit is situated ahead of the center of gravity of said kill-vehicle.

6. The dual control system of claim 2 wherein said tail thruster unit comprises a thrust-vector-control solid rocket.

7. The dual control system of claim 6 wherein said tail thruster unit further comprises a plurality of side jets.

8. The dual control system of claim 7 wherein said tail thruster unit further comprises at least two side jets.

9. The dual control system of claim 3 wherein said nose thruster unit comprises a rocket cluster.

10. The dual control system of claim 9 wherein said rocket cluster comprises at least two solid propellant rockets.

11. The dual control system of claim 10 wherein said rocket-cluster comprises at least one double-nozzled rocket.

12. The dual control system of claim 3 wherein said nose thruster unit comprises at least one rocket mounted upon an extendable arm.

13. The dual control system of claim 12 wherein said extendable arm is retractable into a fuselage of said exoatmospheric kill-vehicle.

14. The dual control system of claim 6 wherein said primary solid propellant propulsion mechanism comprises said thrust-vector-control solid rocket.

15. The dual control system of claim 7 wherein said secondary solid propellant propulsion mechanism comprises said plurality of side jets.

16. The dual control system of claim 5 wherein said secondary solid propellant propulsion mechanism comprises a nose thruster unit.

17. The dual control system of claim 16 wherein said secondary solid propellant propulsion mechanism further comprises a nose thruster unit.

18. The dual control system of claim 1 wherein said second phase of the rocket flight begins within ten missile time-constants of impact.

19. The dual control system of claim 1 wherein at least one propulsion mechanism is controlled by at least one control elements selected from the group consisting of jet shutters, hot gas valves, extendable arms, steerable nozzles and motorized axes.

20. The dual control system of claim 1 wherein at least one propulsion mechanism is controlled by a normally open control element selected from the group consisting of jet shutters and hot gas valves.

21. The dual control system of claim 1 wherein at least one propulsion mechanism is controlled by an autopilot.

22. The dual control system of claim 21 wherein said autopilot receives signals from sensors.

23. The dual control system of claim 21 wherein said autopilot receives signals from a remote control unit.

24. The dual control system of claim 1 wherein said primary propulsion mechanism is characterized by a first missile response time-constant and said secondary propulsion mechanism is characterized by a second missile response time-constant.

25. The dual control system of claim 24 wherein said second missile response time-constant is shorter than said first missile response time-constant.

26. The dual control system of claim 23 where said second missile response time-constant is approximately 0.05 seconds.

27. A method for maneuvering a solid propellant exoatmospheric kill-vehicle towards a moving target, said method comprising:
providing a dual control system comprising a primary solid propellant propulsion mechanism and a secondary solid propellant propulsion mechanism;
maneuvering said kill-vehicle using said primary propulsion mechanism during a first phase of rocket flight, and
maneuvering said kill vehicle towards said target using said secondary propulsion during a second phase of rocket flight.

28. The method of claim 27 wherein said primary propulsion mechanism is characterized by a first missile response time-constant and said secondary propulsion mechanism is characterized by a second missile response time-constant.

29. The method of claim 27 wherein said second phase begins within ten first missile time-constants of impact.
